(19) United States
(12) Patent Application Publication
(10) Pub. No.: US 2017/0108153 A1
(43) Pub. Date: Apr. 20, 2017

(54) LATERAL FITTING INCLUDING OFFSET PARTING PLANE

(71) Applicant: S.P.M. Flow Control, Inc., Fort Worth, TX (US)

(72) Inventors: Brian Witkowski, Weatherford, TX (US); Nadiya Fuller, Plano, TX (US)

(21) Appl. No.: 15/289,449

(22) Filed: Oct. 10, 2016

Related U.S. Application Data
(60) Provisional application No. 62/242,726, filed on Oct. 16, 2015.

(51) Int. Cl. F16L 41/02; B21K 1/14

(52) U.S. Cl. CPC F16L 41/023; F16L 41/021; B21K 1/14

(57) ABSTRACT

A fitting is disclosed that includes a body; a first flow passage extending through the body; and a second flow passage formed in the body to intersect the first flow passage. The first and second flow passages define first and second longitudinal center axes, respectively. In an exemplary embodiment, the fitting forms a portion of a manifold assembly of a frac system. In one aspect, the fitting is formed by a manufacturing process such that the body has a parting plane that is offset from, and parallel to, the first longitudinal center axis. The fitting may have a first varying wall thickness defined between the first flow passage and the external surface; and a second varying wall thickness defined between the second flow passage and the external surface. In another aspect, a curved surface is formed in the body at the intersection between the first and second flow passages.

### CROSS-REFERENCE TO RELATED APPLICATION

This application claims the benefit of the filing date of, and priority to, U.S. Application No. 62/242,726, filed Oct. 16, 2015, the entire disclosure of which is hereby incorporated herein by reference.

### TECHNICAL FIELD

This disclosure relates in general to fittings and, in particular, a lateral fitting including an offset parting plane.

### BACKGROUND OF THE DISCLOSURE

A manifold assembly may include a low pressure manifold and a high pressure manifold. Such a manifold assembly may be used to hydraulically fracture (or “frac”) a subterranean formation by conveying pressurized fluid to a wellbore that extends within the subterranean formation, thereby facilitating oil and gas exploration and production operations. Generally, a fitting within one of these manifold assemblies is subjected to high stress, specifically along a center plane of the fitting that is within an inner “Y” area formed between two intersecting flow paths of the fitting (“center ‘Y’ plane”). Stress within this center Y plane may often be 3.5 times higher than the stress in other areas of the fitting. Therefore, cracks or other failures often propagate along this center Y plane. When the fittings are forged, a parting plane is created in the fitting and is associated with a significant directional grain flow that may reduce the mechanical properties transverse to the plane defined by the parting line. As such, the parting plane is associated with reduced material properties. When the parting plane coincides with the center “Y” plane, the plane within the fitting that is the weakest (i.e., the center Y plane) is subjected to the highest stress. Therefore, what is needed is an assembly or method that addresses one or more of the foregoing issues or other(s).

### SUMMARY

In a first aspect, there is provided a fitting, comprising a body; a first flow passage extending through the body, the first flow passage defining a first longitudinal center axis; and a second flow passage extending through the body to intersect the first flow passage, the second flow passage defining a second longitudinal center axis; wherein the fitting is formed by a manufacturing process such that the body has a parting plane that is offset from, and parallel to, the first longitudinal center axis.

In an exemplary embodiment, the first and second longitudinal center axes are coplanar and thus the parting is offset from, and parallel to, both of the first and second longitudinal center axes.

In another exemplary embodiment, the parting plane is offset from the first longitudinal center axis of the first flow passage by an offset distance that is between about 0.13 inches and about 2 inches.

In yet another exemplary embodiment, the parting plane is offset from the first longitudinal center axis of the first flow passage by an offset distance; the body has an outer dimension that is associated with the first flow passage; and the ratio of the outer dimension to the offset distance is between about four and about eight.

In certain exemplary embodiments, the first flow passage and the second flow passage intersect to form an acute angle.

In an exemplary embodiment, the fitting is a non-symmetrical lateral fitting.

In another exemplary embodiment, the body has a first varying wall thickness defined between the first flow passage and an external surface of the body; the body has a second varying wall thickness defined between the second flow passage and the external surface of the body; and each of the first and second varying wall thicknesses increases at the intersection of the second flow passage and the first flow passage.

In yet another exemplary embodiment, each of the first and second wall thicknesses increases at the intersection of the second flow passage and the first flow passage and in an area between the first flow passage and the second flow passage that forms an acute angle.

In certain exemplary embodiments, the external surface of the body has a varying gradient at the intersection of the second flow passage and the first flow passage.

In an exemplary embodiment, the varying gradient is at least partially defined by a radius of curvature that is greater than one inch.

In another exemplary embodiment, the body has an outer dimension that is associated with the first flow passage; the varying gradient is at least partially defined by a radius of curvature; and the ratio of the outer dimension to the radius of curvature is between about two and about six.

In yet another exemplary embodiment, the intersection formed in the interior of the body between the first and second flow passages circumscribes the second flow passage; and the fitting further comprises a curved surface formed in the body at the intersection, at least a portion of the curved surface being co-planar with a plane in which both of the first and second longitudinal center axes extend.

In yet another exemplary embodiment, the manufacturing process is a forging process in which the fitting is forged between first and second dies.

In a second aspect, there is provided a lateral fitting, comprising a body having an external surface; a first flow passage extending through the body, the first flow passage defining a first longitudinal center axis; and a second flow passage extending through the body to intersect the first flow passage, the second flow passage defining a second longitudinal center axis; wherein the body comprises a first varying wall thickness defined between the first flow passage and the external surface of the body; and a second varying wall thickness defined between the second flow passage and the external surface of the body; and wherein each of the first and second varying wall thicknesses increases at the intersection of the second flow passage and the first flow passage.

In an exemplary embodiment, each of the first and second wall varying thicknesses increases in an area of the body that is within an acute angle formed between the first flow passage and the second flow passage.

In another exemplary embodiment, the external surface of the body has a varying gradient at the intersection of the second flow passage and the first flow passage.

In yet another exemplary embodiment, the varying gradient is at least partially defined by a radius of curvature that is greater than one inch.

In certain exemplary embodiments, the body has an outer dimension that is associated with the first flow passage; the varying gradient is at least partially defined by a radius of curvature; and the ratio of the outer dimension to the radius of curvature is between about two and about six.

In an exemplary embodiment, the fitting is formed by a manufacturing process such that the body has a parting plane that is offset from, and parallel to, the first longitudinal center axis.

In another exemplary embodiment, the first and second longitudinal center axes are coplanar and thus the parting plane is offset from, and parallel to, both of the first and second longitudinal center axes.

In yet another exemplary embodiment, the manufacturing process is a forging process in which the fitting is forged between first and second dies.

In certain exemplary embodiments, the intersection formed in the interior of the body between the first and second flow passages circumscribes the second flow passage; and the fitting further comprises a curved surface formed in the body at the intersection, at least a portion of the curved surface being co-planar with a plane in which both of the first and second longitudinal center axes extend.

In a third aspect, there is provided a method, comprising forging a fitting body, comprising compressing a material, using a first die having a first void volume and a second die having a second void volume that is greater than the first void volume, to form the fitting body so that the fitting body has a straight section and a branch section extending from the straight section; wherein the straight section has a center line; and wherein compressing the material to form the fitting body results in the fitting body having a parting plane that is associated with a relative position of the first die to the second die, the parting plane being offset by an offset distance from the center line of the straight section.

In an exemplary embodiment, the method further comprises forming a first bore through the straight section to create a first flow passage, the first flow passage defining a first longitudinal center axis that is co-axial with the center line of the straight section; and forming a second bore through the branch section to create a second flow passage that intersects the first flow passage, the second flow passage defining a second longitudinal center axis.

In another exemplary embodiment, forming the first bore through the straight section to create the first flow passage defines a first varying wall thickness between the first flow passage and an external surface of the body; forming the second bore through the branch section to create the second flow passage defines a second varying wall thickness between the second flow passage and the external surface of the body; and each of the first and second varying wall thicknesses increases at the intersection of the second flow passage and the first flow passage.

In yet another exemplary embodiment, the first and second longitudinal center axes are coplanar and thus the parting plane is offset from, and parallel to, both of the first and second longitudinal center axes.

In certain exemplary embodiments, the offset distance is between about 0.13 inches and about 2 inches.

In an exemplary embodiment, each of the first and second varying wall thicknesses increases in an area of the body that is within an acute angle formed between the first flow passage and the second flow passage.

In another exemplary embodiment, an external surface of the body has a varying gradient at the intersection of the second flow passage and the first flow passage.

In yet another exemplary embodiment, the varying gradient is at least partially defined by a radius of curvature that is greater than one inch.

In certain exemplary embodiments, the body has an outer dimension that is associated with the first flow passage; the varying gradient is at least partially defined by a radius of curvature; and the ratio of the outer dimension to the radius of curvature is between about two and about six.

In an exemplary embodiment, the method also includes forming a curved surface in the interior of the body at the intersection in the interior of the body between the first and second flow passages, at least a portion of the curved surface being co-planar with a plane in which both of the first and second longitudinal center axes extend.

In a fourth aspect, there is provided a fitting, comprising a body comprising a straight section and a branch section extending from the straight section; a first flow passage extending through the straight section of the body, the first flow passage defining a first longitudinal center axis; a second flow passage extending through the branch section of the body and intersecting the first flow passage, the second flow passage defining a second longitudinal center axis; an intersection formed in the interior of the body between the first and second flow passages, the intersection circumscribing the second flow passage; and a curved surface formed in the body at the intersection, at least a portion of the curved surface being co-planar with a plane in which both of the first and second longitudinal center axes extend.

In an exemplary embodiment, the first and second longitudinal center axes intersect one another to form an acute angle.

In another exemplary embodiment, the portion of the curved surface that is co-planar with the plane in which both of the first and second longitudinal center axes extend is also located angularly between the first and second longitudinal center axes and within the acute angle.

In yet another exemplary embodiment, the fitting is formed by a manufacturing process such that the body has a parting plane that is offset from, and parallel to, the first longitudinal center axis.

In certain exemplary embodiments, at the location of the curved surface, the first and second flow passages form an acute angle with one another.

In an exemplary embodiment, the curved surface defines first and second end portions, the respective first and second end portions being disposed on opposite sides of the plane in which both of the first and second longitudinal center axes extend.

In another exemplary embodiment, the respective first and second end portions of the curved surface are disposed equidistant from the plane in which both of the first and second longitudinal center axes extend.

In yet another exemplary embodiment, the curved surface at least partially defines a radius of curvature.

In certain exemplary embodiments, the radius of curvature is about one inch.

In a fifth aspect, there is provided a method, comprising forging a fitting body so that the fitting body has a straight section and a branch section extending from the straight section; forming a first bore through the straight section of the body to create a first flow passage extending along a first longitudinal center axis; forming a second bore through the branch section of the body to create a second flow passage extending along a second longitudinal center axis and intersecting the first flow passage, wherein the second flow passage defines an intersection in the interior of the body between the first and second flow passages; and forming a curved surface in the interior of the body at the intersection, at least a portion of the curved surface being co-planar with a plane in which both of the first and second longitudinal center axes extend.

In an exemplary embodiment, the first and second longitudinal center axes intersect one another to form an acute angle.

In another exemplary embodiment, the portion of the curved surface that is co-planar with the plane in which both of the first and second longitudinal center axes extend is also located angularly between the first and second longitudinal center axes and within the acute angle.

In yet another exemplary embodiment, the fitting is formed by a manufacturing process such that the body has a parting plane that is offset from, and parallel to, the first longitudinal center axis.

In certain exemplary embodiments, forming the curved surface in the interior of the body at the intersection comprises engaging at least a portion of the intersection with a machine tool that extends within the first flow passage.

In an exemplary embodiment, at the location of the curved surface, the first and second flow passages form an acute angle with one another.

In another exemplary embodiment, the curved surface defines first and second end portions, the respective first and second end portions being disposed on opposite sides of the plane in which both of the first and second longitudinal center axes extend.

In yet another exemplary embodiment, the respective first and second end portions of the curved surface are disposed equidistant from the plane in which both of the first and second longitudinal center axes extend.

In certain exemplary embodiments, the curved surface at least partially defines a radius of curvature.

In an exemplary embodiment, the radius of curvature is about one inch.

Other aspects, features, and advantages will become apparent from the following detailed description when taken in conjunction with the accompanying drawings, which are a part of this disclosure and which illustrate, by way of example, principles of the inventions disclosed.

### DESCRIPTION OF FIGURES

The accompanying drawings facilitate an understanding of the various embodiments.

FIG. 1 is a perspective view of a fitting, according to an exemplary embodiment.

FIG. 2 is a sectional view of the fitting of FIG. 1, according to an exemplary embodiment.

FIG. 3 is another sectional view of the fitting of FIG. 1 taken along line 3-3 of FIG. 2, according to an exemplary embodiment.

FIG. 4 is a flow chart illustration of a method of manufacturing the fitting of FIGS. 1-3, according to an exemplary embodiment.

FIG. 5 is a side view of the fitting of FIG. 1, according to an exemplary embodiment.

FIG. 6 is a bottom view of the fitting of FIG. 1, according to an exemplary embodiment.

FIG. 7 is a sectional view of the fitting of FIG. 1 taken along line 7-7 of FIG. 5, according to an exemplary embodiment.

FIG. 8 is a perspective sectional view of an alternate embodiment of the fitting of FIG. 1, according to an exemplary embodiment.

FIG. 9 is a sectional view of the fitting of FIG. 8, according to an exemplary embodiment.

FIG. 10 is a sectional view of the fitting of FIGS. 8 and 9 taken along line 10-10 of FIG. 9, according to an exemplary embodiment.

FIG. 11 is a flow chart illustration of a method of manufacturing the fitting of FIGS. 8-10, according to an exemplary embodiment.

### DETAILED DESCRIPTION

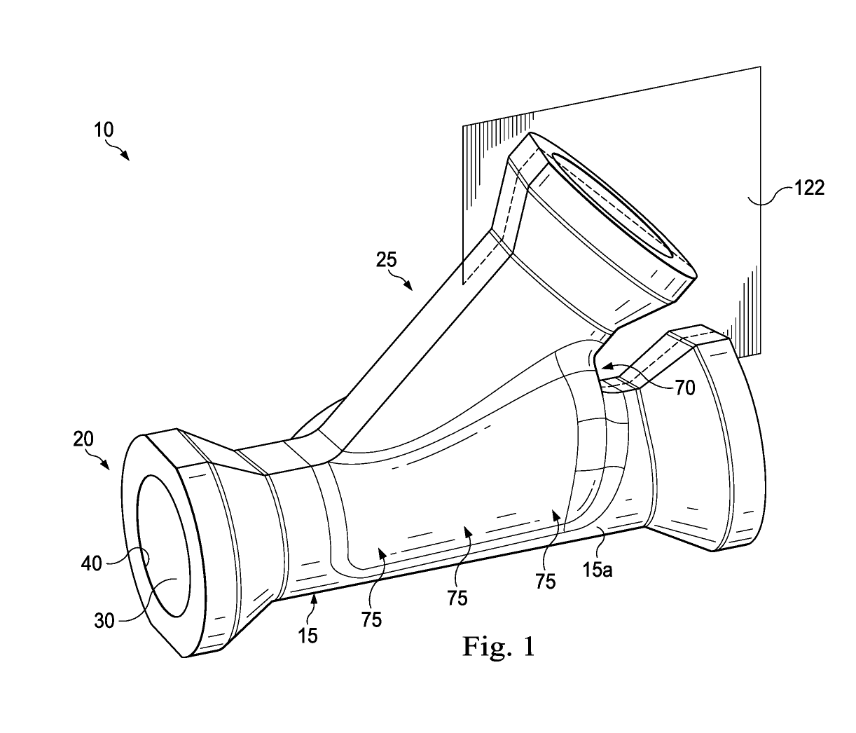

In an exemplary embodiment and as illustrated in FIG. 1, a fitting is generally referred to by the reference numeral 10 and includes a body 15 that forms a straight section 20 and a branch section 25 extending from the straight section 20.

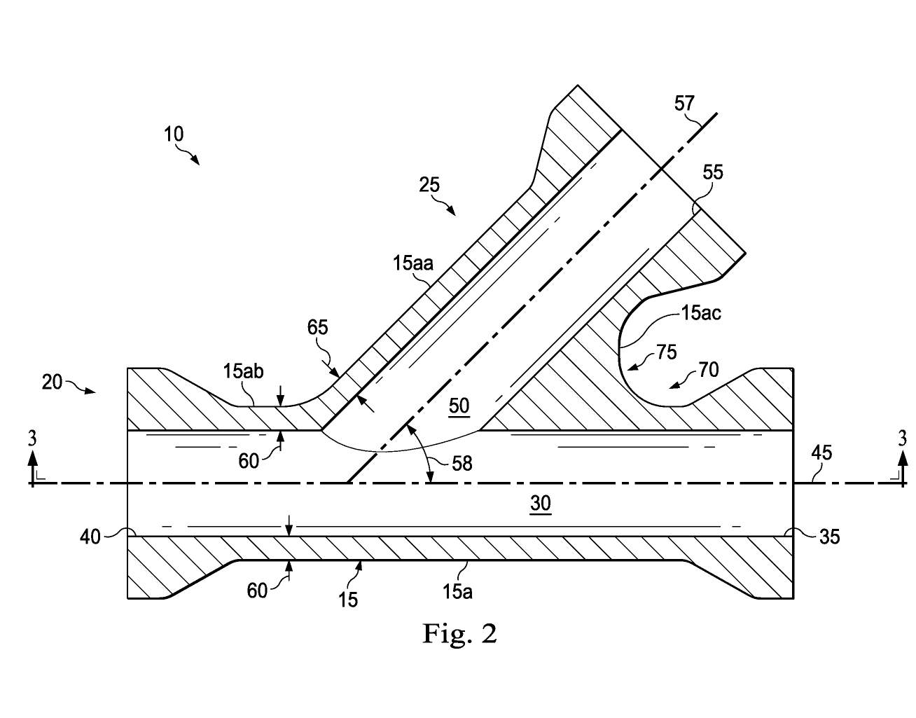

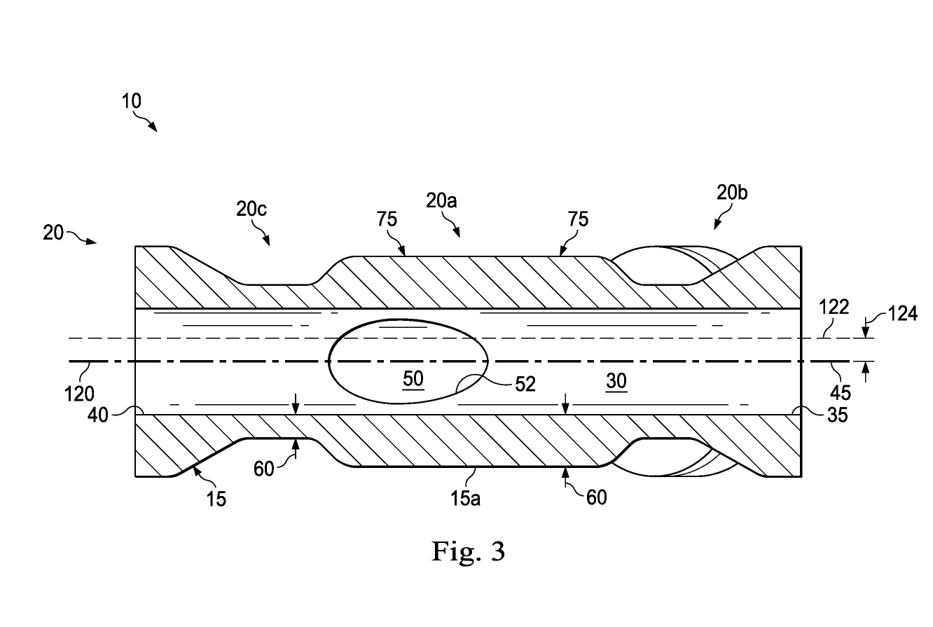

As illustrated in FIGS. 2 and 3, a flow passage 30 extends through the straight section 20 of the body 15 and is associated with a first opening 35 and an opposing second opening 40. The first flow passage defines a longitudinal center axis 45, which is co-axial with a center line of the straight section 20. Additionally, a flow passage 50 is formed in the body 15 and intersects the flow passage 30. An intersection 52 (FIG. 3) is defined in the interior of the body 15. Specifically, the intersection 52 is located at the intersection between the flow passages 30 and 50. The flow passage 50 extends through the branch section 25 and is associated with a third opening 55 of the body 15. The flow passage 50 defines a longitudinal center axis 57. The flow passages 30 and 50 intersect one another so that the longitudinal center axes 45 and 57 form an acute angle 58 with one another. In an exemplary embodiment, the acute angle 58 is a 45 degree angle. In another exemplary embodiment, the acute angle is a 60 degree angle. However, the acute angle 58 may be any angle that is greater than 0 degrees and less than 90 degrees. The fitting 10 is a non-symmetrical lateral fitting. However, in another exemplary embodiment, the fitting may be a symmetrical wye fitting. Generally, the straight section 20 defines a center line that coincides with the longitudinal center axis 45.

Referring still to FIGS. 2 and 3, the body 15 has a wall thickness 60 that is defined between the flow passage 30 and an external surface 15a. The body 15 also has a wall thickness 65 that is defined between the flow passage 50 and the external surface 15a. Each of the wall thicknesses 60 and 65 vary such that the external surface 15a of the body has a varying gradient along the flow passage 30 and along the flow passage 50. In fact, each of the wall thickness 60 and 65 increases at the intersection 52 of the flow passage 50 and the flow passage 30. The wall thicknesses 60 and 65 increase in an area 70 that forms the acute angle 58, between the flow passages 30 and 50. This area 70 (also shown in FIG. 1) is formed between the straight section 20 and the branch section 25 of the body 15 and may also be referred to as the “crotch” of the fitting or the “center ‘Y’ area” of the fitting 10. The wall thicknesses 60 and 65 also increase in an area 75 (also shown in FIG. 1) that is near the intersection 52 of the flow passages 30 and 50 and that is along the flow passage 30.

The varying gradient of the external surface 15a results in a thicker wall of the body 15 at, near, and around, the intersection 52 of the flow passages 30 and 50 than in other areas of the body 15 that are associated with the flow passages 30 and 50. For example, a first portion 15aa of the external surface 15a associated with the flow passage 50 may form an obtuse angle with a second portion 15ab of the external surface 15a that is associated with the flow passage 30. Additionally, a third portion 15ac of the external surface 15a is associated with the area 70. The wall thickness 65 associated with the first portion 15aa is less than the wall thicknesses 60 and 65 associated with the third portion 15ac. Additionally, the wall thickness 60 associated with the second portion 15ab is less than the wall thicknesses 60 and 65 associated with the third portion 15ac. Similarly, the wall thickness 60 associated with a middle portion 20a of the straight section 20 is greater than the wall thickness 60 associated with opposing end portions 20b and 20c of the straight section 20 since the intersection 52 of the flow passages 30 and 50 is located at or near the middle portion 20a of the straight section 20.

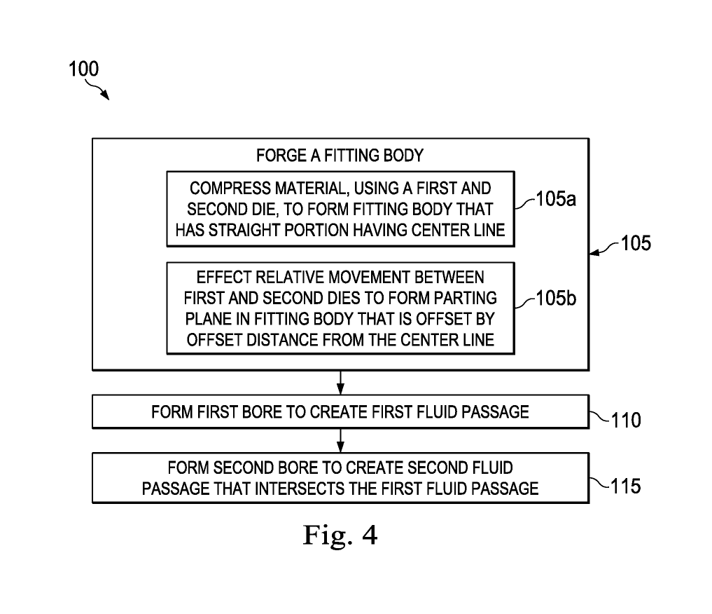

In an exemplary embodiment, as illustrated in FIG. 4 with continuing reference to FIGS. 1-3, a method 100 of manufacturing the fitting 10 includes forging the fitting body 15 at step 105, forming a first bore to create the flow passage 30 at step 110, and forming a second bore to create the flow passage 50 that intersects the flow passage 30 at step 115.

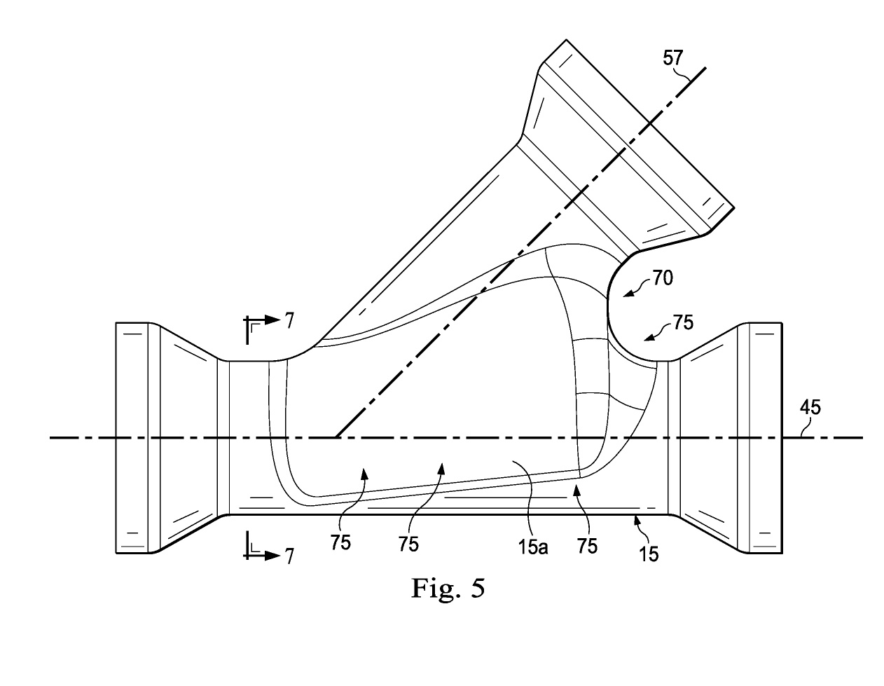

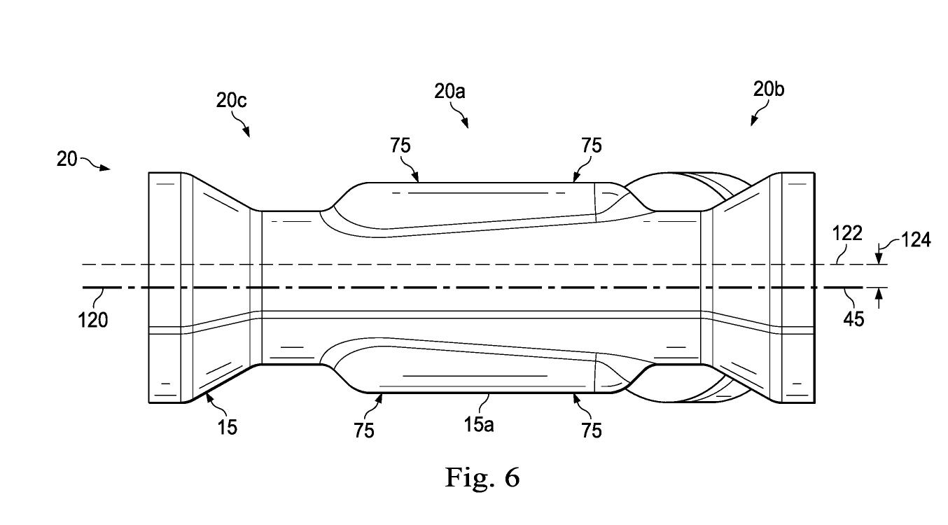

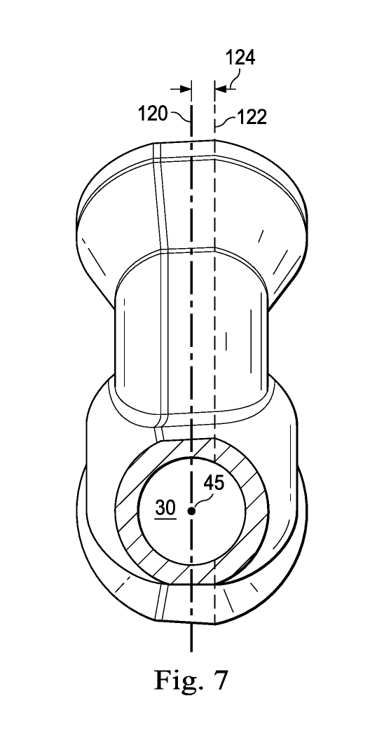

Referring to FIGS. 5-7, the step 105 includes the sub-steps of compressing a material, using a first and second die, to form the fitting body 15 that has the straight section 20 having the center line that extends within a plane 120 in which both the longitudinal center axes 45 and 57 extend at step 105a, and effecting relative movement between the first die and the second die to form a parting plane 122 in the fitting body 15 that is offset by an offset distance 124 (FIGS. 6 and 7) from the center line at step 105b.

At the step 105a, compressing the material, using the first and second dies, forms the body 15, the straight section 20 having the center line that coincides with the longitudinal center axis 45, and the branch section 25. In several exemplary embodiments, the material compressed at the step 105a includes one or more metal materials, or any combination thereof.

At the step 105b, the first die engages the second die to form the parting plane 122 in the fitting body 15, as shown in FIGS. 3, 6, and 7. However, in other forging processes, the step 105 may include effecting relative movement between the first die and the second die without engaging the first die and the second die, to form the parting plane 122 in the fitting body 15. As illustrated in FIGS. 3, 6, and 7, the parting plane 122 is offset from the center line of the straight section 20 by the offset distance 124. The offset distance 124 is one inch, but may be between about 0.13 inches and about 2 inches. However, the offset distance 124 may be dependent upon the size of the fitting 10. Generally, the ratio of the outer dimension associated with the flow passage 50 to the offset distance 124 is between about four and about eight. Thus, for a fitting having a larger size, the offset distance 124 may be larger than one inch and for a fitting having a smaller size, the offset distance 124 may be smaller than one inch. The first die has a first void volume and the second die has a second void volume that is greater than the first void volume so that the parting plane 122 does not coincide with the longitudinal center axes 45 and 57 and the center line of the straight section 20. That is, the fitting 10 is formed using a non-symmetrical forging die to shift the parting plane 122 away from the plane 120 in which both the longitudinal center axes 45 and 57 extend.

At the step 110, a first bore is formed to create the flow passage 30 (FIGS. 2 and 3). The first bore may be formed by, for example, milling, lathing, etc.

At the step 115, a second bore is formed to create the flow passage 50 that intersects the flow passage 30. As the longitudinal center axes 45 and 57 are coplanar within the plane 120, the parting plane 122 is offset from, and parallel to, both of the longitudinal center axes 45 and 57 and the plane 120. The first and second bores are formed to define the first wall thickness 60 and the second wall thickness 65.

As illustrated in FIGS. 4-6, the varying gradient of the external surface 15a is at least partially defined by a radius of curvature, such as a radius of curvature that is greater than one inch, such as about 1.5 inches. However, the radius of curvature may be dependent upon the size of the fitting 10. For example, the radius of curvature is about 1.5 inches when an outer dimension associated with the flow passage 50 or the branch section 25 is about six inches. Generally, the ratio of the outer dimension associated with the flow passage 50 or the branch section 25 to the radius of curvature may be between two and six. Thus, the radius of curvature is not limited to about 1.5 inches, and instead, may increase or decrease based on the size of the fitting.

The varying gradient of the external surface 15a is optimized such that the mass of the fitting 10 is increased in areas that experience high stress (i.e., areas 70 and 75) to increase rigidity and toughness of the fitting 10 while minimizing the weight of the fitting 10. Minimizing the weight may also reduce cost, as less material is required to produce the fitting 10.

In an exemplary embodiment, the first, second, and third openings 35, 40, and 55 may be internally threaded (not shown) openings to engage an externally threaded component or pipe fitting. In one or more exemplary embodiments, the fitting 10 forms a portion of a hydraulic fracturing or “frac” system, which pumps fluid to a wellhead for the purpose of propagating fractures in a formation through which a wellbore extends. For example, the fitting 10 forms a portion of a manifold assembly of the frac system. However, the fitting 10 is not limited to a frac system and may be used in any type of fluid or pipe system. In operation, when the fitting 10 forms a portion of a manifold assembly of the frac system, fluid enters the openings 35 and 55, flows through the fitting 10, and exits the opening 40.

During operation of the fitting 10, stress within the plane 120 is often much greater than in other areas of the fitting 10. Additionally, the parting plane 122 is associated with a disrupted grain structure of the material forming the fitting 10. As such, the parting plane 122 is associated with reduced material properties. Thus, the offset of the parting plane 122 from the plane 120 prevents or delays a failure originating within a portion of the fitting 10 within the plane 120. Additionally, the offset of the parting plane 122 from the plane 120 slows or discourages any propagation of failures that may originate in the plane 120.

Additionally, increasing the wall thicknesses 60 and 65 at or near the intersection 52 of the flow passage 30 and the second flow passage 50 increases rigidity of the fitting 10 by selectively increasing mass of the fitting 10. In one or more exemplary embodiments, the increased wall thicknesses 60 and 65 results in a 5% reduction of stress within the plane 120 and reduces the propagation of cracks originating in the plane 120. Increasing the wall thicknesses 60 and 65 also results in increased toughness of the fitting 10. In an exemplary embodiment, the varying gradient in the external surface 15a is a result of the optimization of increased rigidity to weight reduction.

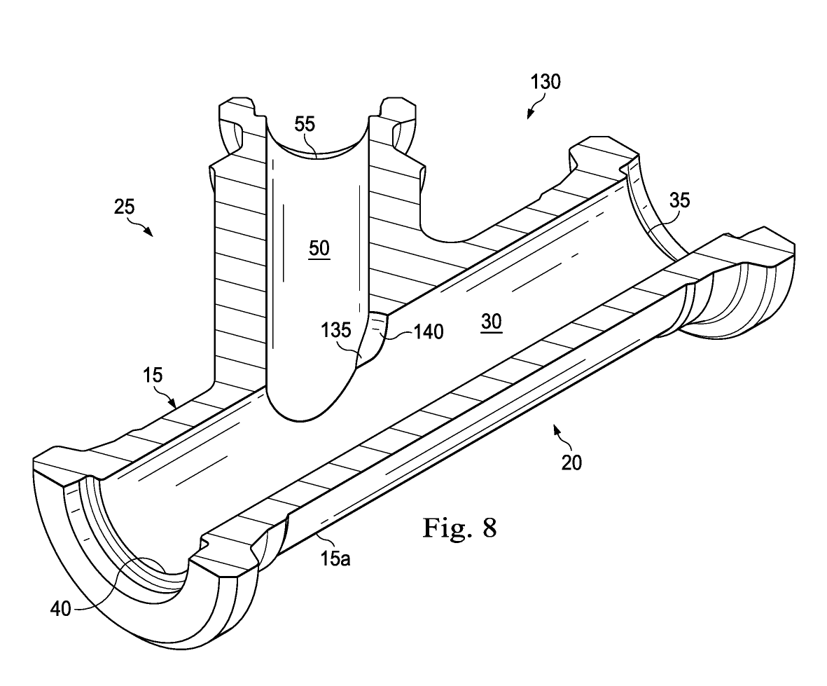

In another exemplary embodiment, as illustrated in FIG. 8, a fitting is generally referred to by the reference numeral 130. The fitting 130 includes several components that are identical to, or at least similar to, corresponding components of the fitting 10; these identical or similar components are given the same reference numerals.

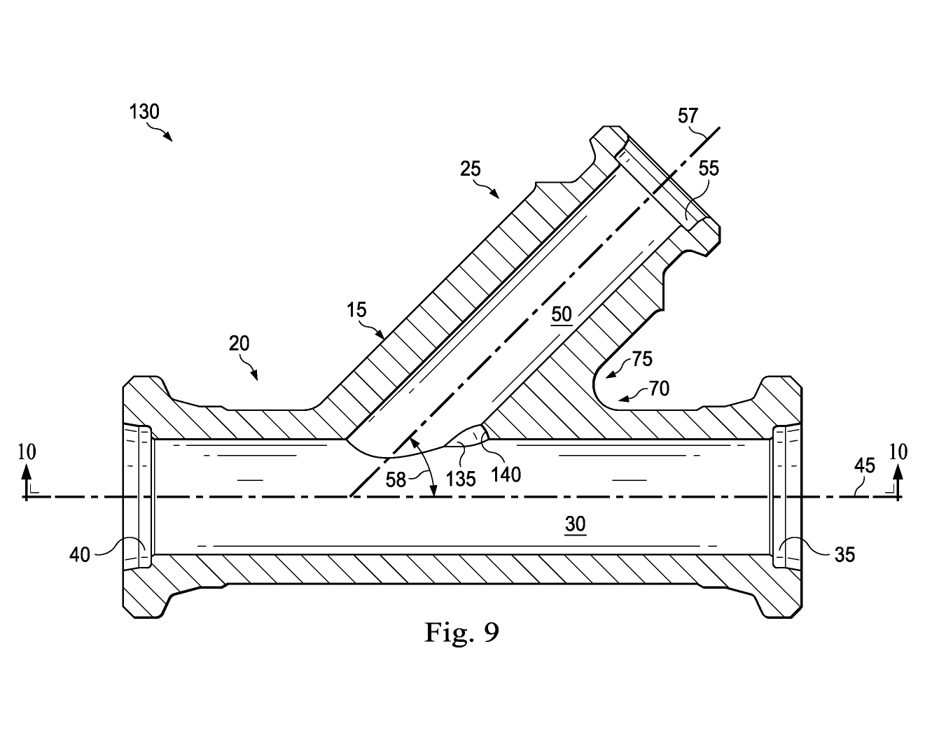

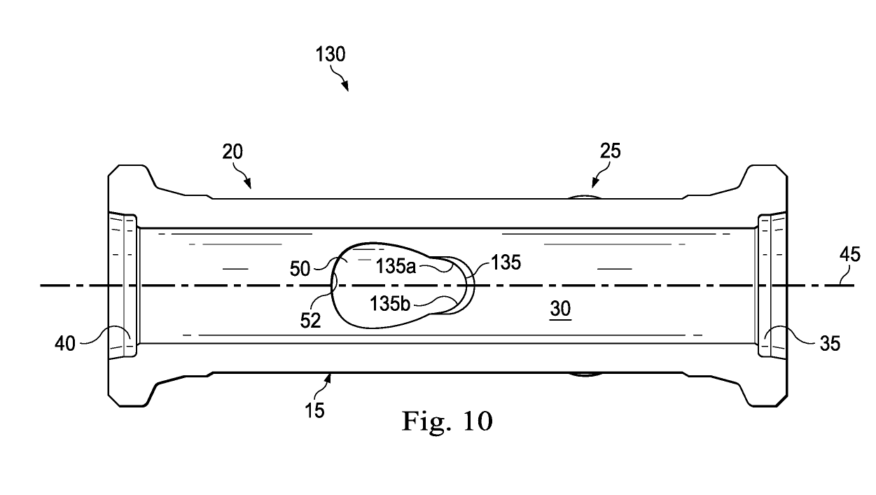

As illustrated in FIGS. 9 and 10, with continuing reference to FIG. 8, the fitting 130 includes a modified bore intersection feature, such as, for example, a curved surface 135, formed in the interior of the body 15 at the intersection 52. At the location of the curved surface 135, the flow passages 30 and 50, respectively, form an acute angle with one another. Further, the curved surface 135 extends interior and adjacent the area 70 and respective portions of the areas 75. Further still, at least a portion of the curved surface 135 is co-planar with the plane in which the longitudinal center axes 45 and 57 extend, said portion being located angularly between the longitudinal center axes 45 and 57 and within the acute angle 58. The curved surface 135 defines opposing end portions 135a and 135b (FIG. 10). In several exemplary embodiments, the opposing end portions 135a and 135b are disposed on opposite sides of the plane in which both of the longitudinal center axes 45 and 57 extend. In several exemplary embodiments, the opposing end portions 135a and 135b are disposed equidistant from the plane in which both of the longitudinal center axes 45 and 57 extend. Further, the curved surface 135 is at least partially defined by a radius of curvature 140, such as, for example, a radius of curvature that is about one inch. However, the radius of curvature 140 is not limited to about one inch, and instead, may be greater or less than one inch, depending on the size of the fitting 130.

In several exemplary embodiments, the curved surface 135 decreases the amount of stress in the fitting body 15 at or near the intersection 52 of the flow passages 30 and 50. This decrease in the amount of stress in the fitting body 15 may be greater than approximately 5 percent, 10 percent, 15 percent, 20 percent, 25 percent, 30 percent, 35 percent, 40 percent, or more. In an exemplary embodiment, the curved surface 135 decreases the amount of stress in the fitting body 15 by approximately 43 percent.

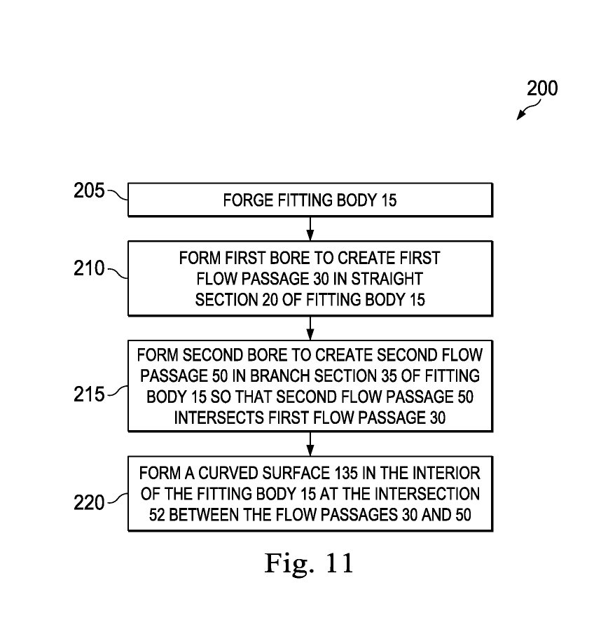

In an exemplary embodiment, as illustrated in FIG. 11 with continuing reference to FIGS. 8-10, a method 200 of manufacturing the fitting 130 includes forging the fitting body 15 at step 205, forming a first bore to create the flow passage 30 at step 210, forming a second bore to create the flow passage 50 that intersects the flow passage 30 at step 215, and forming the curved surface 135 along the intersection 52 to create the modified bore intersection feature in the body 15 at step 220.

At the step 205, the fitting body 15 is forged so that the fitting body 15 has the straight section 20 and the branch section 25 extending from the straight section 20. The fitting body 15 may be formed by a manufacturing process such that the parting plane 122 of the fitting body 15 is offset from, and parallel to, the first and/or the second longitudinal center axes 45 and 57, respectively. Alternatively, the fitting body 15 may be forged by another manufacturing process such that the parting plane 122 of the fitting body 15 is not offset from the first and/or the second longitudinal center axes 45 and 57, respectively.

At the step 210, the first bore is formed through the straight section 20 to create the flow passage 30. The first bore may be formed by, for example, milling, lathing, etc.

At the step 215, the second bore is formed through the branch section 25 to create the flow passage 50, which intersects the flow passage 30. The second bore may be formed by, for example, milling, lathing, etc. The formation of the second bore creates the intersection 52 in the interior of the body 15 at the intersection between the flow passages 30 and 50.

At the step 220, the curved surface 135 is formed in the intersection 52 between the flow passages 30 and 50. The curved surface 135 is formed by engaging at least a portion of the intersection with a machine tool (not shown) that extends through the second opening 40 and within the flow passage 30. Further, the curved surface 135 may be formed by, for example, milling, lathing, etc.

In an exemplary embodiment, the fitting 10 also includes the modified bore intersection feature, such as, for example, the curved surface 135, formed in the interior of the body 15 at the intersection 52.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used to provide reference points and are not to be construed as limiting terms.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, additions and/or changes can be made thereto without departing from the scope and spirit of the disclosed embodiments, the embodiments being illustrative and not restrictive.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

What is claimed is:

1. A fitting, comprising:
a body;
a first flow passage extending through the body, the first flow passage defining a first longitudinal center axis; and
a second flow passage extending through the body to intersect the first flow passage, the second flow passage defining a second longitudinal center axis;
wherein the fitting is formed by a manufacturing process such that the body has a parting plane that is offset from, and parallel to, the first longitudinal center axis.

2. The fitting of claim 1, wherein the first and second longitudinal center axes are coplanar and thus the parting plane is offset from, and parallel to, both of the first and second longitudinal center axes; and wherein the fitting is a non-symmetrical lateral fitting.

3. The fitting of claim 1, wherein the parting plane is offset from the first longitudinal center axis of the first flow passage by an offset distance that is between about 0.13 inches and about 2 inches.

4. The fitting of claim 1,
wherein the parting plane is offset from the first longitudinal center axis of the first flow passage by an offset distance;
wherein the body has an outer dimension that is associated with the first flow passage;
wherein the ratio of the outer dimension to the offset distance is between about four and about eight; and
wherein the first flow passage and the second flow passage intersect to form an acute angle.

5. The fitting of claim 1,
wherein the body has a first varying wall thickness defined between the first flow passage and an external surface of the body;
wherein the body has a second varying wall thickness defined between the second flow passage and the external surface of the body;
wherein each of the first and second varying wall thicknesses increases at the intersection of the second flow passage and the first flow passage and in an area between the first flow passage and the second flow passage that forms an acute angle; and
wherein the external surface of the body has a varying gradient at the intersection of the second flow passage and the first flow passage.

6. The fitting of claim 5,
wherein the varying gradient is at least partially defined by a radius of curvature that is greater than one inch;
wherein the body has an outer dimension that is associated with the first flow passage; and
wherein the ratio of the outer dimension to the radius of curvature is between about two and about six.

7. The fitting of claim 1,
wherein the intersection formed in the interior of the body between the first and second flow passages circumscribes the second flow passage; and
wherein the fitting further comprises a curved surface formed in the body at the intersection, at least a portion of the curved surface being co-planar with a plane in which both of the first and second longitudinal center axes extend.

8. The fitting of claim 1, wherein the manufacturing process is a forging process in which the fitting is forged between first and second dies.

9. A lateral fitting, comprising:
a body having an external surface;
a first flow passage extending through the body, the first flow passage defining a first longitudinal center axis; and
a second flow passage extending through the body to intersect the first flow passage, the second flow passage defining a second longitudinal center axis;
wherein the body comprises:
a first varying wall thickness defined between the first flow passage and the external surface of the body; and
a second varying wall thickness defined between the second flow passage and the external surface of the body; and
wherein each of the first and second varying wall thicknesses increases at the intersection of the second flow passage and the first flow passage.

10. The lateral fitting of claim 9,
wherein each of the first and second wall varying thicknesses increases in an area of the body that is within an acute angle formed between the first flow passage and the second flow passage;
wherein the external surface of the body has a varying gradient at the intersection of the second flow passage and the first flow passage; and
wherein the varying gradient is at least partially defined by a radius of curvature that is greater than one inch.

11. The lateral fitting of claim 9,
wherein the intersection formed in the interior of the body between the first and second flow passages circumscribes the second flow passage; and
wherein the lateral fitting further comprises a curved surface formed in the body at the intersection, at least a portion of the curved surface being co-planar with a plane in which both of the first and second longitudinal center axes extend.

12. The lateral fitting of claim 10,
wherein the body has an outer dimension that is associated with the first flow passage;
wherein the varying gradient is at least partially defined by a radius of curvature; and
wherein the ratio of the outer dimension to the radius of curvature is between about two and about six.

13. The lateral fitting of claim 9,
wherein the fitting is formed by a manufacturing process such that the body has a parting plane that is offset from, and parallel to, the first longitudinal center axis;
wherein the first and second longitudinal center axes are coplanar and thus the parting plane is offset from, and parallel to, both of the first and second longitudinal center axes; and
wherein the manufacturing process is a forging process in which the fitting is forged between first and second dies.

14. A method, comprising:
forging a fitting body, comprising compressing a material, using a first die having a first void volume and a second die having a second void volume that is greater than the first void volume, to form the fitting body so that the fitting body has a straight section and a branch section extending from the straight section;
wherein the straight section has a center line; and
wherein compressing the material to form the fitting body results in the fitting body having a parting plane that is associated with a relative position of the first die to the second die, the parting plane being offset by an offset distance from the center line of the straight section.

15. The method of claim 14, further comprising:
forming a first bore through the straight section to create a first flow passage, the first flow passage defining a first longitudinal center axis that is co-axial with the center line of the straight section; and
forming a second bore through the branch section to create a second flow passage that intersects the first flow passage, the second flow passage defining a second longitudinal center axis.

16. The method of claim 15,
wherein forming the first bore through the straight section to create the first flow passage defines a first varying wall thickness between the first flow passage and an external surface of the body;
wherein forming the second bore through the branch section to create the second flow passage defines a second varying wall thickness between the second flow passage and the external surface of the body; and
wherein each of the first and second varying wall thicknesses increases at the intersection of the second flow passage and the first flow passage.

17. The method of claim 15,
wherein the first and second longitudinal center axes are coplanar and thus the parting plane is offset from, and parallel to, both of the first and second longitudinal center axes; and
wherein the offset distance is between about 0.13 inches and about 2 inches.

18. The method of claim 15, further comprising forming a curved surface in the interior of the body at the intersection in the interior of the body between the first and second flow passages, at least a portion of the curved surface being co-planar with a plane in which both of the first and second longitudinal center axes extend.

19. The method of claim 16,
wherein each of the first and second varying wall thicknesses increases in an area of the body that is within an acute angle formed between the first flow passage and the second flow passage; and
wherein the fitting body has an outer dimension that is associated with the first flow passage.
wherein an external surface of the body has a varying gradient at the intersection of the second flow passage and the first flow passage;
wherein the varying gradient is at least partially defined by a radius of curvature; and
wherein the ratio of the outer dimension to the radius of curvature is between about two and about six.

20. The method of claim 15,
wherein an external surface of the fitting body has a varying gradient at the intersection of the second flow passage and the first flow passage; and
wherein the varying gradient is at least partially defined by a radius of curvature that is greater than one inch.

21. A fitting, comprising:
a body comprising a straight section and a branch section extending from the straight section;
a first flow passage extending through the straight section of the body, the first flow passage defining a first longitudinal center axis;
a second flow passage extending through the branch section of the body and intersecting the first flow passage, the second flow passage defining a second longitudinal center axis;
an intersection formed in the interior of the body between the first and second flow passages, the intersection circumscribing the second flow passage; and
a curved surface formed in the body at the intersection, at least a portion of the curved surface being co-planar with a plane in which both of the first and second longitudinal center axes extend;
wherein the first and second longitudinal center axes intersect one another to form an acute angle; and
wherein the portion of the curved surface that is co-planar with the plane in which both of the first and second longitudinal center axes extend is also located angularly between the first and second longitudinal center axes and within the acute angle.

22. The fitting of claim 21, wherein the fitting is formed by a manufacturing process such that the body has a parting plane that is offset from, and parallel to, the first longitudinal center axis.

23. The fitting of claim 21, wherein, at the location of the curved surface, the first and second flow passages form the acute angle with one another.

24. The fitting of claim 21,
wherein the curved surface defines first and second end portions, the respective first and second end portions being disposed on opposite sides of the plane in which both of the first and second longitudinal center axes extend; and
wherein the respective first and second end portions of the curved surface are disposed equidistant from the plane in which both of the first and second longitudinal center axes extend.

25. The fitting of claim 24, wherein the curved surface at least partially defines a radius of curvature; and wherein the radius of curvature is about one inch.
